(19) United States
(12) Patent Application Publication
(10) Pub. No.: US 2017/0125837 A1
(43) Pub. Date: May 4, 2017

(54) BATTERY STRUCTURE

(71) Applicant: ADVANCED MICRO ELECTRONIS CO., LTD., New Taipei City (TW)

(72) Inventor: Chieh-Chi CHEN, New Taipei City (TW)

(21) Appl. No.: 15/403,973

(22) Filed: Jan. 11, 2017

Related U.S. Application Data
(62) Division of application No. 13/332,219, filed on Dec. 20, 2011.

(30) Foreign Application Priority Data
Dec. 21, 2010 (CN) 201010609223.X

(51) Int. Cl. H01M 10/04; H01M 4/78

(52) U.S. Cl. CPC H01M 10/0477; H01M 4/78

(57) ABSTRACT

A battery structure includes at least one electrode lamination layer, at least one first conductive member and at least one second conductive member. Each electrode lamination layer includes a plurality of first electrode layers, a plurality of second electrode layers and a plurality of insulating layers, wherein each insulating layer is disposed between any immediately-adjacent two of the first electrode layers and second electrode layers. The electrode lamination layer is disposed between the first conductive member and the second conductive member, wherein each first electrode layer or each second electrode layer is electrically connected with and substantially perpendicular to the first conductive member or the second conductive member.

### RELATED APPLICATIONS

This application is a Divisional Application of the U.S. application Ser. No. 13/332,219, filed Dec. 20, 2011, which claims priority to China Application Serial Number 201010609223.X, filed Dec. 21, 2010, both of which are herein incorporated by reference.

### BACKGROUND

Field of Invention

The present invention relates to a battery structure.

Description of Related Art

An electrochemical battery is a device capable of deriving electrical energy from chemical reactions or facilitating chemical reactions through the introduction of electrical energy. Each half-cell consists of an electrode and an electrolyte. Each electrochemical battery includes two half-cells, which may use the same electrolyte or different electrolytes. The chemical reactions in the cell may involve the electrolyte, the electrodes or an external substance.

Due to a long development of the electrochemical battery, many types of battery structures are provided for extensive applications. The battery structure can be a huge design to be accommodated in big building or a tiny design in millimeter scale. Modern electronics development requires high demands for the electrochemical battery. Each breakthrough in electrochemical battery technology brings a huge advance on electronics development.

There are many types of conventional battery structures in the market, but there is still a need for improving battery structures to deal with bottlenecks on extensive applications.

### SUMMARY

It is therefore an objective of the present invention to provide a battery structure with an improved design.

In accordance with the foregoing and other objectives of the present invention, a battery structure includes at least one electrode lamination layer, at least one first conductive member and at least one second conductive member. Each electrode lamination layer includes a plurality of first electrode layers, a plurality of second electrode layers and a plurality of insulating layers, wherein each insulating layer is disposed between any immediately-adjacent two of the first electrode layers and the second electrode layers. The electrode lamination layer is disposed between the first conductive member and the second conductive member, wherein each first electrode layer or each second electrode layer is electrically connected with and substantially perpendicular to the first conductive member or the second conductive member.

In another embodiment disclosed herein, an insulating gap is defined between each insulating layer and the first conductive member.

In another embodiment disclosed herein, an insulating gap is defined between each insulating layer and the second conductive member.

In another embodiment disclosed herein, the first conductive member is a hollow conductive member, and the second conductive member is a solid pillar conductive member disposed at a central axis position of the hollow conductive member.

In another embodiment disclosed herein, the hollow conductive member has a circular cross-section.

In another embodiment disclosed herein, the hollow conductive member has a convex polygon cross-section.

In another embodiment disclosed herein, the first conductive member is a flat sheet of conductive member.

In another embodiment disclosed herein, the second conductive member is a flat sheet of conductive member.

In another embodiment disclosed herein, when there are at least two electrode lamination layers, at least one third conductive member is interconnected between any immediately-adjacent two of the at least two electrode lamination layers.

In another embodiment disclosed herein, the third conductive member is interconnected between the first electrode layers of either one of the at least two electrode lamination layers and the second electrode layers of another one of the at least two electrode lamination layers.

In another embodiment disclosed herein, the third conductive member is interconnected between the first electrode layers of either one of the at least two electrode lamination layers and the first electrode layers of another one of the at least two electrode lamination layers.

In another embodiment disclosed herein, the third conductive member is interconnected between the second electrode layers of either one of the at least two electrode lamination layers and the second electrode layers of another one of the at least two electrode lamination layers.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A illustrates a cross-sectional view of a battery structure according to a first embodiment of this invention;

FIG. 1B illustrates a cross-sectional view taken along a cross-sectional line 1B-1B′ in FIG. 1A;

FIG. 2A illustrates a cross-sectional view of a battery structure according to a second embodiment of this invention;

FIG. 2B illustrates a cross-sectional view taken along a cross-sectional line 2B-2B′ in FIG. 2A;

FIG. 3A illustrates a cross-sectional view of a battery structure according to a third embodiment of this invention;

FIG. 3B illustrates a cross-sectional view taken along a cross-sectional line 3B-3B′ in FIG. 3A;

FIG. 4A illustrates a cross-sectional view of a battery structure according to a fourth embodiment of this invention;

FIG. 4B illustrates a cross-sectional view taken along a cross-sectional line 4B-4B′ in FIG. 4A;

FIG. 5A illustrates a cross-sectional view of a battery structure according to a fifth embodiment of this invention;

FIG. 5B illustrates a cross-sectional view taken along a cross-sectional line 5B-5B′ in FIG. 5A;

FIG. 6A illustrates a cross-sectional view of a battery structure according to a sixth embodiment of this invention;

FIG. 6B illustrates a cross-sectional view taken along a cross-sectional line 6B-6B′ in FIG. 6A;

FIG. 7A illustrates a cross-sectional view of a battery structure according to a seventh embodiment of this invention; and

FIG. 7B illustrates a cross-sectional view taken along a cross-sectional line 7B-7B′ in FIG. 7A.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

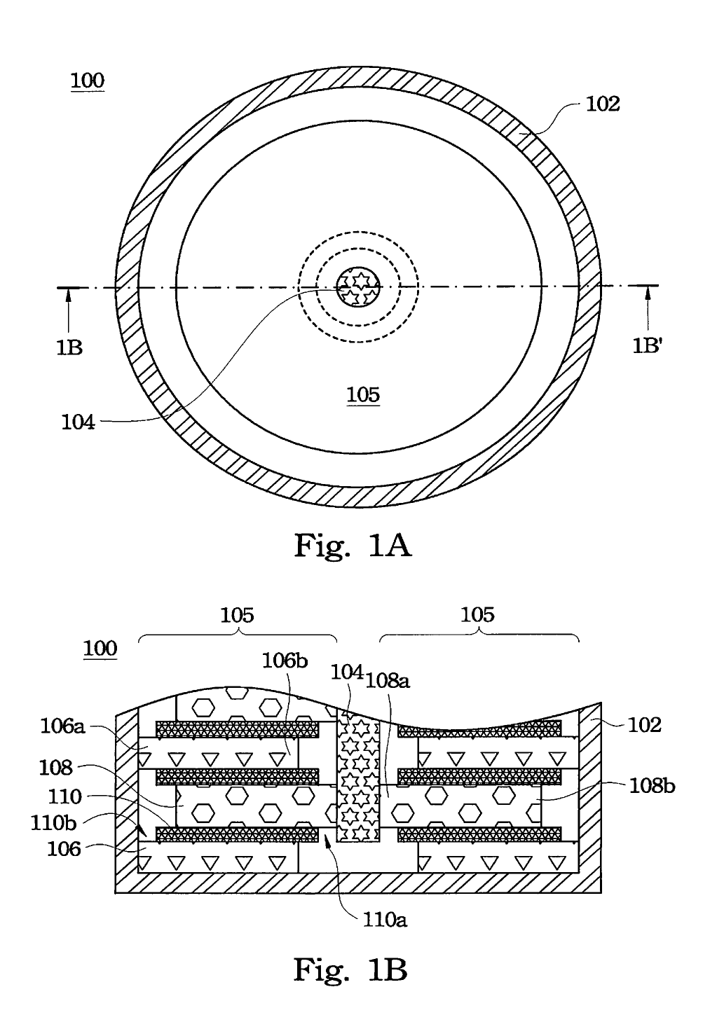

Referring to both FIG. 1A and FIG. 1B, FIG. 1A illustrates a cross-sectional view of a battery structure according to a first embodiment of this invention, and FIG. 1B illustrates a cross-sectional view taken along a cross-sectional line 1B-1B′ in FIG. 1A. A battery structure 100 includes a first conductive member 102, a second conductive member 104 and an electrode lamination layer 105 located therebetween. In this embodiment, the first conductive member 102 is a hollow conductive member with a circular cross-section, and the second conductive member 104 is a solid pillar conductive member, which serves as a central axis of the first conductive member 102. The electrode lamination layer 105 includes a plurality of laminated first electrode layers 106, a plurality of second electrode layers 108 and a plurality of insulating layers 110, and each insulating layer 110 is laminated between any adjacent-two of the first electrode layers 106 and second electrode layers 108. The first electrode layers 106 and the second electrode layers 108 are so-called “anode” (positive electrode) and “cathode” (negative electrode), which are made from proper conventional materials. In this embodiment, each first electrode layer 106 or each second electrode layer 108 is electrically connected with and substantially perpendicular to the first conductive member 102 or the second conductive member 104. This battery design benefits to manufacturing a battery conveniently. In conventional cylinder-shaped batteries, the anode and the cathode are in parallel with a hollow cylinder conductive housing. In particular, a sheet of electrode lamination layer should be first rolled into a cylindered-shape to be installed within the hollow cylinder conductive housing, and extra process steps are needed to attach anodes or cathodes of the electrode lamination layer to respective conductive members.

In this embodiment, the first electrode layer 106 of the electrode lamination layer 105 is in direct contact with the first conductive member 102 while the second electrode layer 108 of the electrode lamination layer 105 is in direct contact with the second conductive member 104, and no extra connection member or process step is needed.

In order to have all the first electrode layers 106 of the electrode lamination layer 105 in direct contact with the first conductive member 102, all first electrode layers 106 have respective connection ends 106a aligned with one another. In addition, all the first electrode layers 106 have respective opposite connection ends 106b insulated from the second conductive member 104.

In order to have all the second electrode layers 108 of the electrode lamination layer 105 in direct contact with the second conductive member 104, all the second electrode layers 108 have respective connection ends 108a aligned with one another. In addition, all the second electrode layers 108 have respective opposite connection ends 108b insulated from the first conductive member 102.

In addition, two opposite ends of the insulating layers 110 are respectively insulated from the first conductive member 102 and the second conductive member 104 by insulating gaps (110a, 110b). The insulating gaps (110a, 110b) may vary according to different batteries, but the insulating layers 110 should not interfere the connection between the conductive member and the first electrode layer 106 or second electrode layer 108, and should be able to avoid a short circuit between the first electrode layer 106 and the second electrode layer 108.

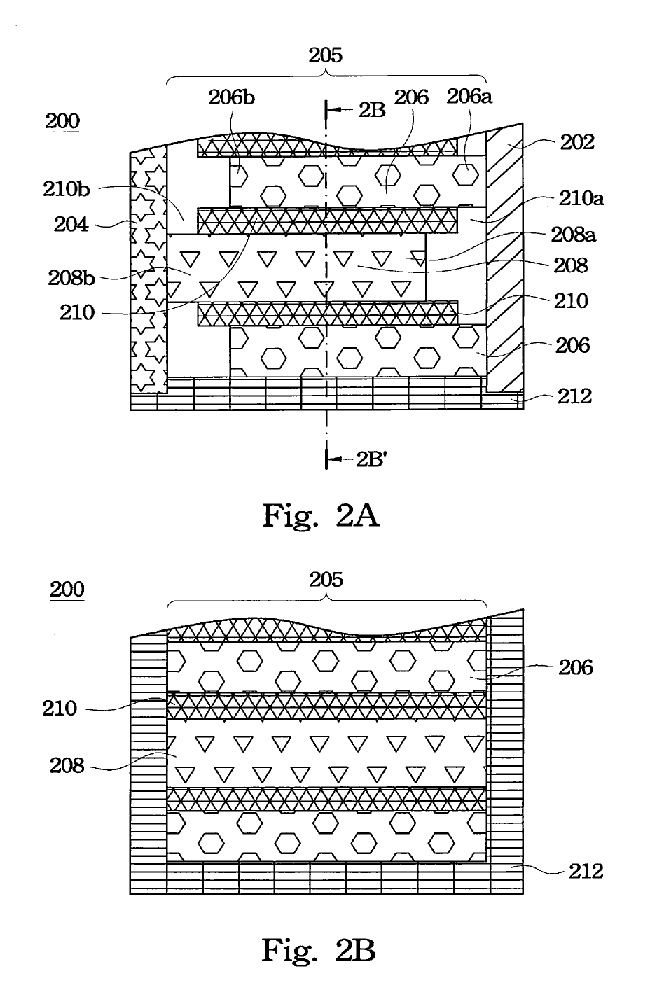

Referring both to FIGS. 2A and 2B, FIG. 2A illustrates a cross-sectional view of a battery structure according to a second embodiment of this invention, and FIG. 2B illustrates a cross-sectional view taken along a cross-sectional line 2B-2B′ in FIG. 2A. The second embodiment is different from the first embodiment in the shape of the battery structure. The first embodiment is directed to a cylinder while the second embodiment is to a rectangular body. A battery structure 200 includes a first conductive member 202, a second conductive member 204 and an electrode lamination layer 205 located therebetween. In this embodiment, the first conductive member 202 and the second conductive member 204 are two flat sheets of conductive members, and an insulating housing 212 is interconnected therebetween. The electrode lamination layer 205 includes a plurality of laminated first electrode layers 206, a plurality of second electrode layers 208 and a plurality of insulating layers 210, and each insulating layer 210 is laminated between any adjacent-two of the first electrode layers 206 and second electrode layers 208. The first electrode layers 206 and second electrode layers 208 are so-called “anode” (positive electrode) and “cathode” (negative electrode), which are made from proper conventional materials. In this embodiment, each first electrode layer 206 or each second electrode layer 208 is electrically connected with and substantially perpendicular to the first conductive member 202 or the second conductive member 204. This battery design benefits to manufacturing a battery conveniently. In conventional similar batteries, the anode and cathode are in parallel with their conductive housing. In particular, a sheet of electrode lamination layer should be rolled first to be installed within the conductive housing, and extra process steps are needed to attach anodes or cathodes of the electrode lamination layer to respective conductive members.

In this embodiment, the first electrode layer 206 of the electrode lamination layer 205 is in direct contact with the first conductive member 202 while the second electrode layer 208 of the electrode lamination layer 105 is in direct contact with the second conductive member 204, and no extra connection member or process step is needed.

In order to have all the first electrode layers 206 of the electrode lamination layer 205 in direct contact with the first conductive member 202, all first electrode layers 206 have respective connection ends 206a aligned with one another. In addition, all first electrode layers 206 have respective opposite connection ends 206b insulated from the second conductive member 204.

In order to have all the second electrode layers 208 of the electrode lamination layer 205 in direct contact with the second conductive member 204, all second electrode layers 208 have respective connection ends 208b aligned with one another. In addition, all second electrode layers 208 have respective opposite connection ends 208a insulated from the first conductive member 202.

In addition, two opposite ends of the insulating layers 210 are respectively insulated from the first conductive member 202 and the second conductive member 204 by insulating gaps (210a, 210b). The insulating gaps (210a, 210b) may vary according to different batteries, but the insulating layers 210 should not interfere connection between the conductive member and the first electrode layer 206 or the second electrode layer 208, and should be able to avoid a short circuit between the first electrode layer 206 and the second electrode layer 208.

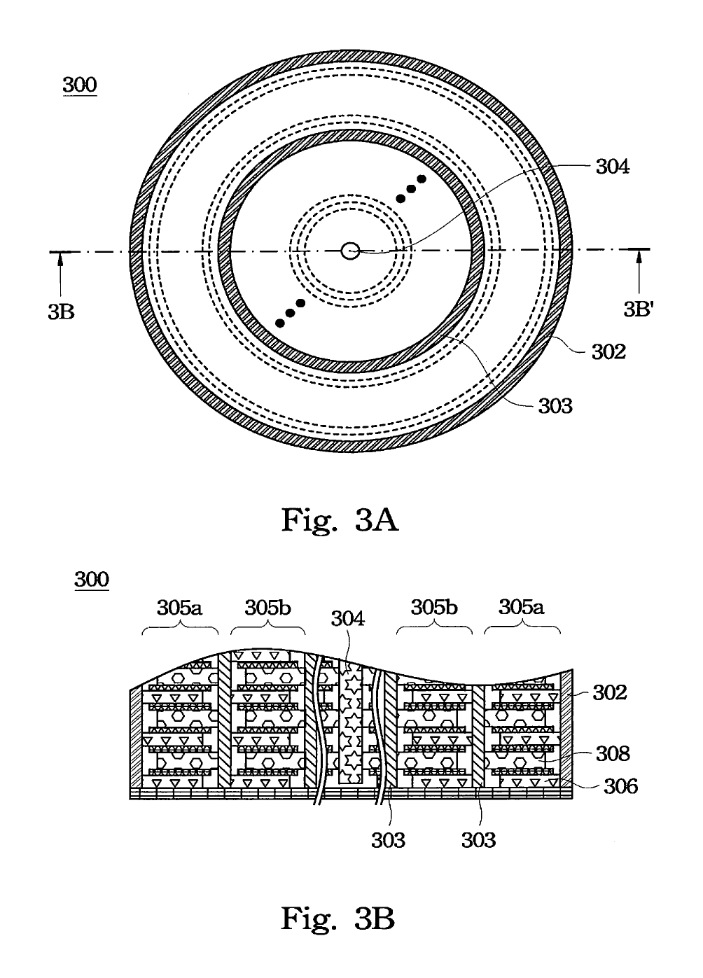

Referring both to FIGS. 3A and 3B, FIG. 3A illustrates a cross-sectional view of a battery structure according to a third embodiment of this invention, and FIG. 3B illustrates a cross-sectional view taken along a cross-sectional line 3B-3B′ in FIG. 3A. The third embodiment is different from the first embodiment in the number of the electrode lamination layers. The first embodiment has only one electrode lamination layer while the third embodiment has at least two electrode lamination layers to be serially connected.

A battery structure 300 includes a first conductive member 302, a second conductive member 304 and a plurality of electrode lamination layers, e.g., electrode lamination layers (305a, 305b) serially connected between two conductive members (302, 304).

In this embodiment, the first conductive member 302 is a hollow conductive member with a circular cross-section, and the second conductive member 304 is solid pillar conductive member, which serves as a central axis of the first conductive member 302. Each electrode lamination layer (305a, 305b) includes a plurality of laminated first electrode layers 306, a plurality of second electrode layers 308 and a plurality of insulating layers 310, and each insulating layer 310 is laminated between any adjacent-two of the first electrode layers 306 and the second electrode layers 308. The first electrode layers 306 and the second electrode layers 308 are so-called an “anode” (positive electrode) and a “cathode” (negative electrode), which are made from proper conventional materials. In this embodiment, each first electrode layer 306 or each second electrode layer 308 is electrically connected with and substantially perpendicular to the first conductive member 302, the second conductive member 304 or the third conductive member 303. As to the term “substantially perpendicular to” used herein, it means that an included angle between the electrode layer and the conductive member is about 90 degrees, i.e., ranging from 80 degrees to 100 degrees.

Adjacent electrode lamination layers (305a, 305b) are serially connected by a third conductive member 303. That is, a first electrode layer of an electrode lamination layer, e.g., 305a, is serially connected with a second electrode layer of an adjacent electrode lamination layer, e.g., 305b, by the third conductive member 303. Alternately, a second electrode layer of an electrode lamination layer, e.g., 305a, is serially connected with a first electrode layer of an adjacent electrode lamination layer, e.g., 305b, by the third conductive member 303. In this embodiment, the electrode lamination layers (305a, 305b) are connected with the adjacent conductive members by the same ways, i.e., “electrically connected with and substantially perpendicular to”, as discussed in the battery structure 100, thereby being equipped with the same advantages in manufacturing.

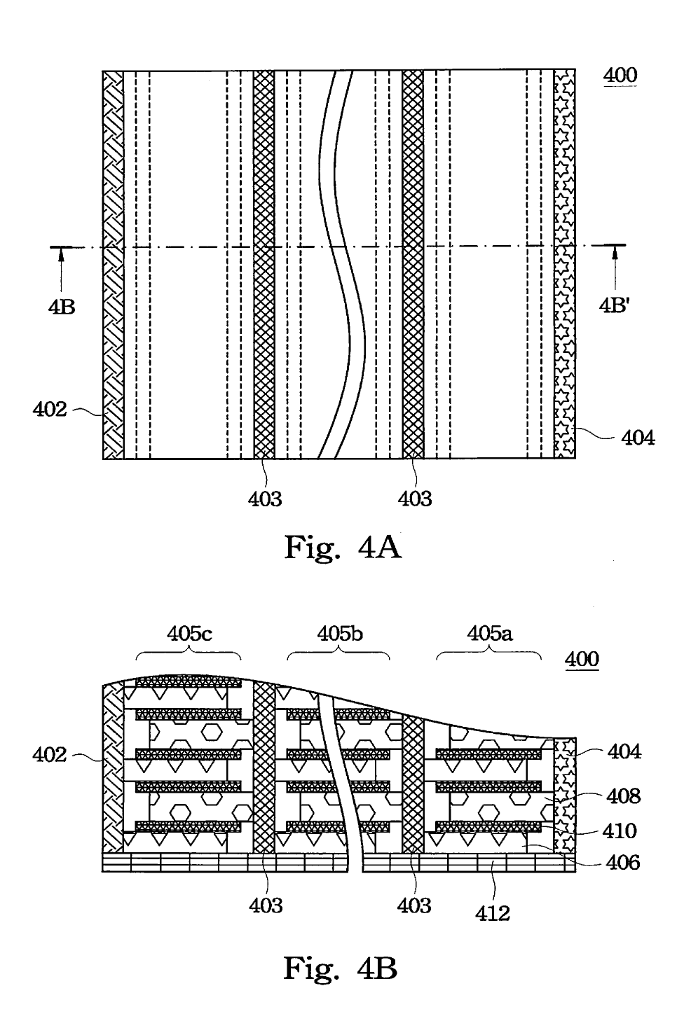

Referring to FIG. 4A and FIG. 4B, FIG. 4A illustrates a cross-sectional view of a battery structure according to a fourth embodiment of this invention, and FIG. 4B illustrates a cross-sectional view taken along a cross-sectional line 4B-4B′ in FIG. 4A.

The fourth embodiment is different from the second embodiment in the number of the electrode lamination layers. The second embodiment has only one electrode lamination layer while the fourth embodiment has at least two electrode lamination layers to be serially connected.

The battery structure 400 includes a first conductive member 402, a second conductive member 404 and a plurality of electrode lamination layers, e.g., electrode lamination layers (405a, 405b, 405c) serially connected between two conductive members (402, 404). In this embodiment, the first conductive member 402 and the second conductive member 404 are two flat sheets of conductive members, and an insulating housing 412 is interconnected therebetween. Each electrode lamination layer (405a, 405b, 405c) includes a plurality of laminated first electrode layers 406, a plurality of second electrode layers 408 and a plurality of insulating layers 410, and each insulating layer 410 is laminated between any adjacent-two of the first electrode layers 406 and second electrode layers 408. The first electrode layers 406 and the second electrode layers 408 are so-called “anode” (positive electrode) and “cathode” (negative electrode), which are made from proper conventional materials. In this embodiment, each first electrode layer 406 or each second electrode layer 408 is electrically connected with and substantially perpendicular to the first conductive member 402, the second conductive member 404 or the third conductive member 403. As to the term “substantially perpendicular to” used herein, it means an included angle between the electrode layer and the conductive member is about 90 degrees, i.e., ranging from 80 degrees to 100 degrees.

Adjacent electrode lamination layers (405a, 405b, 405c) are serially connected by a third conductive member 403. That is, a first electrode layer of an electrode lamination layer, e.g., 405a, is serially connected with a second electrode layer of an adjacent electrode lamination layer, e.g., 405b, by the third conductive member 403. Alternately, a second electrode layer of an electrode lamination layer, e.g., 405a, is serially connected with a first electrode layer of an adjacent electrode lamination layer, e.g., 405b, by the third conductive member 403.

In this embodiment, the electrode lamination layers (405a, 405b, 405c) are connected with the adjacent conductive members by the same ways, i.e., “electrically connected with and substantially perpendicular to”, as discussed in the battery structure 200, thereby being equipped with the same advantages in manufacturing.

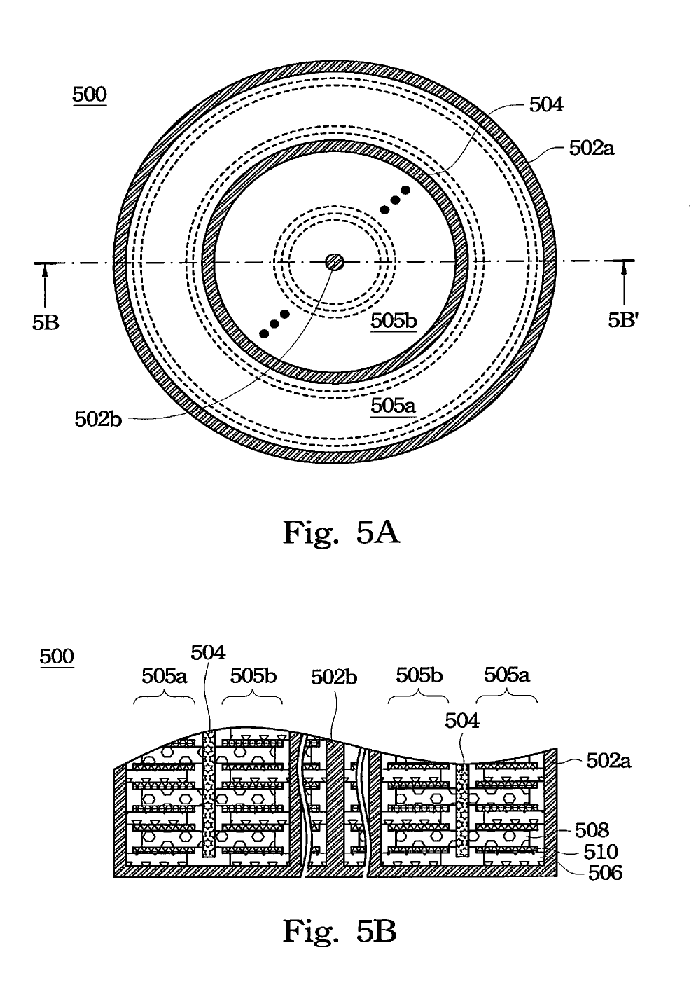

Referring to both FIG. 5A and FIG. 5B, FIG. 5A illustrates a cross-sectional view of a battery structure according to a fifth embodiment of this invention, and FIG. 5B illustrates a cross-sectional view taken along a cross-sectional line 5B-5B′ in FIG. 5A. The fifth embodiment is different from the first embodiment in the number of the electrode lamination layers. The first embodiment has only one electrode lamination layer while the fifth embodiment has at least two electrode lamination layers to be connected in parallel. The fifth embodiment is different from the third embodiment in the connection way between the electrode lamination layers. The third embodiment has a plurality of electrode lamination layers to be serially connected while the fifth embodiment has a plurality of electrode lamination layers to be connected in parallel.

A battery structure 500 includes a plurality of first conductive members (502a, 502b), a plurality of second conductive members 504 and a plurality of electrode lamination layers, i.e., electrode lamination layers (505a, 505b) to be connected in parallel between two conductive members. In this embodiment, the first conductive member 502a is a hollow conductive member with a circular cross-section, and the first conductive member 502b is a solid pillar conductive member, which serves as a central axis of the first conductive member 502a. The second conductive member 504 is also a hollow conductive member with a circular cross-section. Each electrode lamination layer (505a, 505b) includes a plurality of laminated first electrode layers 506, a plurality of second electrode layers 508 and a plurality of insulating layers 510, and each insulating layer 510 is laminated between any adjacent-two of the first electrode layers 506 and second electrode layers 508. The first electrode layers 506 and the second electrode layers 508 are so-called an “anode” (positive electrode) and a “cathode” (negative electrode), which are made from proper conventional materials. In this embodiment, each first electrode layer 506 or each second electrode layer 508 is electrically connected with and substantially perpendicular to the first conductive members (502a, 502b) or the second conductive member 504. As to the term “substantially perpendicular to” used herein, it means an included angle between the electrode layer and the conductive member is about 90 degrees, i.e., ranging from 80 degrees to 100 degrees.

Adjacent electrode lamination layers (505a, 505b) are connected in parallel by the first conductive member (502a, 502b) or second conductive member 504. That is, a first electrode layer of an electrode lamination layer, e.g., 505a, is connected in parallel with a first electrode layer of an adjacent electrode lamination layer, e.g., 505b, by the first conductive member (502a, 502b) or second conductive member 504. Alternately, a second electrode layer of an electrode lamination layer, e.g., 505a, is connected in parallel with a second electrode layer of an adjacent electrode lamination layer, e.g., 505b, by the first conductive member (502a, 502b) or second conductive member 504. In addition, the first conductive members (502a, 502b) are connected with each other, and the second conductive members 504 are connected with each other.

In this embodiment, the electrode lamination layers (502a, 502b) are connected with the adjacent conductive members by the same ways, i.e., “electrically connected with and substantially perpendicular to”, as discussed in the battery structure 100, thereby being equipped with the same advantages in manufacturing.

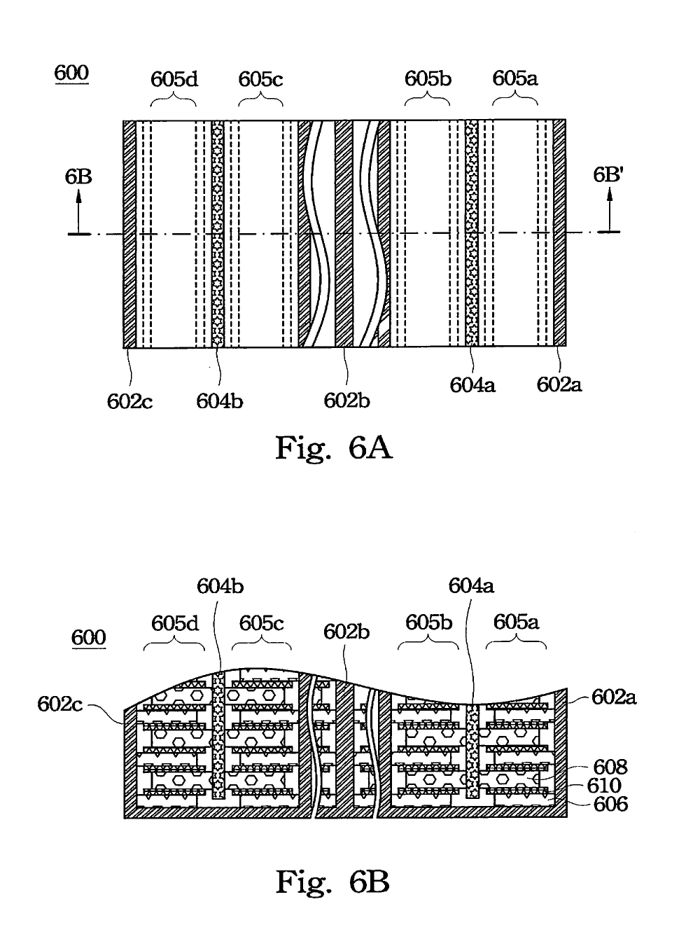

Referring to both FIG. 6A and FIG. 6B, FIG. 6A illustrates a cross-sectional view of a battery structure according to a sixth embodiment of this invention, and FIG. 6B illustrates a cross-sectional view taken along a cross-sectional line 6B-6B′ in FIG. 6A. The sixth embodiment is different from the second embodiment in the number of the electrode lamination layers. The second embodiment has only one electrode lamination layer while the sixth embodiment has at least two electrode lamination layers to be connected in parallel. The sixth embodiment is different from the fourth embodiment in the connection way between the electrode lamination layers. The fourth embodiment has a plurality of electrode lamination layers to be serially connected while the sixth embodiment has a plurality of electrode lamination layers to be connected in parallel.

A battery structure 600 includes a first conductive member (602a, 602b, 602c), a second conductive member (604a, 604b) and a plurality of electrode lamination layers (605a, 605b, 605c, 605d) connected between any immediately-adjacent two conductive members. In this embodiment, the first conductive member (602a, 602b, 602c) and the second conductive member (604a, 604b) are all flat sheets of conductive members. Each electrode lamination layer (605a, 605b, 605c, 605d) includes a plurality of laminated first electrode layers 606, a plurality of second electrode layers 608 and a plurality of insulating layers 610, and each insulating layer 610 is laminated between any immediately-adjacent two of the first electrode layers 606 and second electrode layers 608. The first electrode layers 606 and the second electrode layers 608 are so-called “anode” (positive electrode) and “cathode” (negative electrode), which are made from proper conventional materials. In this embodiment, each first electrode layer 606 or each second electrode layer 608 is electrically connected with and substantially perpendicular to the first conductive members (602a, 602b, 602c) or the second conductive member (604a, 604b). As to the term “substantially perpendicular to” used herein, it means an included angle between the electrode layer and the conductive member is about 90 degrees, i.e., ranging from 80 degrees to 100 degrees.

Adjacent electrode lamination layers (605a, 605b, 605c, 605d) are connected in parallel by the first conductive member (602a, 602b, 602c) or the second conductive member (604a, 604b). That is, a first electrode layer of an electrode lamination layer, e.g., 605a, is connected in parallel with a first electrode layer of an adjacent electrode lamination layer, e.g., 605b, by the first conductive member (602a, 602b, 602c) or second conductive member (604a, 604b). Alternately, a second electrode layer of an electrode lamination layer, e.g., 605a, is connected in parallel with a second electrode layer of an adjacent electrode lamination layer, e.g., 605b, by the first conductive member (602a, 602b, 602c) or second conductive member (604a, 604b). In addition, the first conductive members (602a, 602b, 602c) are connected with one another and the second conductive members (604a, 604b) are connected with each other.

In this embodiment, the electrode lamination layers (605a, 605b, 605c, 605d) are connected with the adjacent conductive members by the same ways, i.e., “electrically connected with and substantially perpendicular to”, as discussed in the battery structure 200, thereby being equipped with the same advantages in manufacturing.

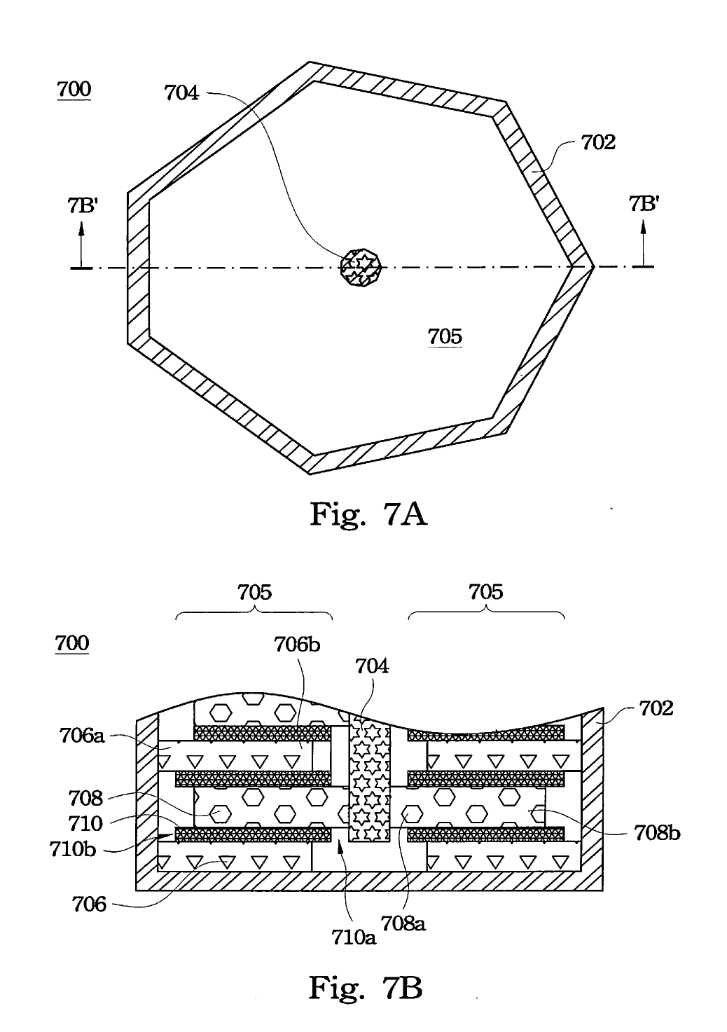

Referring to FIG. 7A and FIG. 7B, FIG. 7A illustrates a cross-sectional view of a battery structure according to a seventh embodiment of this invention, and FIG. 7B illustrates a cross-sectional view taken along a cross-sectional line 7B-7B′ in FIG. 7A. The seventh embodiment is different from the first, second embodiment in the shape of the battery structure. The first embodiment is directed to a cylinder with a circular cross-section, the second embodiment is to a rectangular body, and the seventh embodiment is a cylinder with a convex polygon cross-section.

The battery structure 700 includes a first conductive member 702, a second conductive member 704 and an electrode lamination layer 705 located therebetween. In this embodiment, the first conductive member 702 is a hollow conductive member with a convex polygon cross-section, e.g., a heptagon cross-section illustrated in FIG. 7A, and the second conductive member 704 is a solid pillar conductive member located at a central position of the first conductive member 702. The electrode lamination layer 705 includes a plurality of laminated first electrode layers 706, a plurality of second electrode layers 708 and a plurality of insulating layers 710, and each insulating layer 710 is laminated between any adjacent-two first electrode layer 106 and second electrode layer 108. The first electrode layers 706 and the second electrode layers 708 are so-called “anode” (positive electrode) and “cathode” (negative electrode), which are made from proper conventional materials. In this embodiment, each first electrode layer 706 or each second electrode layer 708 is electrically connected with and substantially perpendicular to the first conductive member 702 or the second conductive member 704. This battery design benefits to manufacturing a battery conveniently. In conventional similar batteries, the anode and the cathode are arranged in parallel with a hollow conductive housing. In particular, a sheet of electrode lamination layer should be first rolled into a similar shape to be installed within the hollow conductive housing, and extra process steps are needed to attach anodes or cathodes of the electrode lamination layer to respective conductive members.

In this embodiment, the first electrode layer 706 of the electrode lamination layer 705 is in direct contact with the first conductive member 702 while the second electrode layer 708 of the electrode lamination layer 705 is in direct contact with the second conductive member 704, and no extra connection member or process step is needed.

In order to have all the first electrode layers 706 of the electrode lamination layer 705 in direct contact with the first conductive member 702, all first electrode layers 706 have respective connection ends 706a aligned with one another. In addition, all the first electrode layers 706 have respective opposite connection ends 706b insulated from the second conductive member 704.

In order to have all the second electrode layers 708 of the electrode lamination layer 705 in direct contact with the second conductive member 704, all the second electrode layers 708 have respective connection ends 708a aligned with one another. In addition, all the second electrode layers 708 have respective opposite connection ends 708b insulated from the first conductive member 702.

In addition, two opposite ends of the insulating layers 710 are respectively insulated from the first conductive member 702 and second conductive member 704 by an insulating gap (710a, 710b). The insulating gap (710a, 710b) may vary according to different batteries, but the insulating layers 710 should not interfere connection between the conductive member and the first electrode layer 106 or the second electrode layer 108, and should be able to avoid a short circuit between the first electrode layer 106 and the second electrode layer 108.

According to the above-discussed embodiments, the battery structure disclosed herein is equipped with the feature “the electrode layer being electrically connected with and substantially perpendicular to the conductive member”, such that an electrode lamination layer can be installed into a conductive housing without being pre-rolled or pre-bent. In addition, the first electrode layer and the second electrode layer of the electrode lamination layer can be in direct contact with the conductive member, and no extra connection member or process step is needed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A battery structure comprising:
a first conductive member and a second conductive member, wherein the first conductive member and the second conductive member are flat sheets of conductive members;
at least an electrode lamination layer disposed between the first conductive member and the second conductive member,
wherein a long axis of each first electrode layer or each second electrode layer is electrically connected with and substantially perpendicular to a long axis of the first conductive member or the second conductive member,
wherein the electrode lamination layer comprises a plurality of first electrode layers, a plurality of second electrode layers and a plurality of insulating layers, each insulating layer being disposed between any immediately-adjacent two of the first electrode layers and the second electrode layers,
wherein either one of the first electrode layers of the electrode lamination layer is in direct contact with the first conductive member while either one of the second electrode layers of the electrode lamination layer is in direct contact with the second conductive member,
wherein the first, second electrode layers and the insulating layers are all flat sheets that are in parallel with one another, and
wherein a first insulating gap is defined between a first end of each insulating layer and the first conductive member, a second insulating gap is defined between a second opposite end of each insulating layer and the second conductive member.

2. A battery structure comprising:
a first conductive member and a second conductive member, wherein the first conductive member and the second conductive member are flat sheets of conductive members;
at least an electrode lamination layer disposed between the first conductive member and the second conductive member,
wherein a long axis of each first electrode layer or each second electrode layer is electrically connected with and substantially perpendicular to a long axis of the first conductive member or the second conductive member,
wherein the electrode lamination layer comprises a plurality of first electrode layers, a plurality of second electrode layers and a plurality of insulating layers, each insulating layer being disposed between any immediately-adjacent two of the first electrode layers and the second electrode layers,
wherein all the first electrode layers of the electrode lamination layer is in direct contact with the first conductive member while all the second electrode layers of the electrode lamination layer is in direct contact with the second conductive member,
wherein the first, second electrode layers and the insulating layers are all flat sheets that are in parallel with one another, and
wherein a first insulating gap is defined between a first end of each insulating layer and the first conductive member, a second insulating gap is defined between a second opposite end of each insulating layer and the second conductive member.
